(19) United States
(12) Patent Application Publication
(10) Pub. No.: US 2010/0127939 A1
(43) Pub. Date: May 27, 2010

(54) PATCH ANTENNA WITH METAL WALLS

(75) Inventor: Hiroyuki Yusa, Tokyo (JP)

Correspondence Address: YOUNG & THOMPSON, 209 Madison Street, Suite 500, Alexandria, VA, 22314, US

(73) Assignee: NEC CORPORATION, TOKYO (JP)

(21) Appl. No.: 12/596,671

(22) PCT Filed: Apr. 25, 2008
(86) PCT No.: PCT/JP2008/058066

§ 371 Date: Oct. 20, 2009

(30) Foreign Application Priority Data
Apr. 27, 2007 (JP) 2007-118946

(51) Int. Cl. H01Q 1/38

(52) U.S. Cl. 343/700 MS

(57) ABSTRACT

A patch antenna is provided with a metallic wall (1); a patch conductor (4) formed on a printed board (2), i.e., a dielectric substrate, by etching or the like; and a power feeding means for the patch conductor. The metallic wall (1) is bent forward along the both side surfaces of the printed board (2). The metallic wall (1) is inclined inward, and an interval between the both end portions is smaller than a radiation aperture dimension of the patch antenna when viewed from an antenna radiation direction. With such configuration, a directional beam width can be widened, and the directional beam width on a surface parallel to the polarization surface of linearly-polarized wave and the directional beam width on a surface orthogonally intersecting with the polarization surface of the linearly-polarized wave are accorded with each other.

### TECHNICAL FIELD

The present invention relates to a patch antenna, and more particularly, relates to a patch antenna chiefly used in a base station of a wireless system that requires a plurality of antenna elements such as diversity and MIMO (Multiple Input Multiple Output).

### BACKGROUND ART

In systems that employ WiMAX (Worldwide Interoperability for Microwave Access) technology or next-generation portable telephone systems, MIMO technology and diversity technology are frequently used, and smaller antennas and lower costs are in demand. A MIMO system requires a plurality of antennas, and antennas that feature little cross correlation in a small area have therefore become necessary.

To meet this demand, a dual-polarized antenna is sought that can be used for both a vertically polarized wave and a horizontally polarized wave. Further, an antenna configuration is sought in which the directional beam width matches vertically polarized waves and horizontally polarized waves such that the radiation area is the same. A reflector dipole antenna is used as this type of antenna.

FIGS. 1 and 2 show an outer perspective view of a reflector dipole antenna that is used as a base station antenna. FIG. 1 is an example of a reflector dipole antenna that is configured by using a printed dipole antenna in which an antenna pattern is formed on a printed board. FIG. 2 shows an example of a reflector dipole antenna that is configured by using a coaxial cable.

The example of a reflector dipole antenna that uses a printed dipole antenna is made up of reflector 11, printed antenna pattern 12 that are formed on both sides of a printed board, and coaxial connector 13 for supplying power, as shown in FIG. 1. Setting up this reflector dipole antenna such that the printed board surface is in the vertical direction, as shown in FIG. 1, enables transmission and reception by vertically polarized waves. Setting up this reflector dipole antenna by rotating the printed dipole antenna 90° from the state shown in FIG. 1 such that the printed dipole antenna is in the horizontal direction enables transmission and reception by horizontally polarized waves.

Antennas used in base stations of wireless systems frequently employ antennas in which a plurality of these dipole antenna elements is aligned in a plurality of array shapes. However, a dipole antenna has a comparatively large shape and is therefore disadvantageous from the standpoints of smaller size and lower cost. In addition, dipole antennas have suffered from the problem in which directivity within the horizontal plane of the antennas for vertically polarized waves and directivity within the horizontal plane of antennas for horizontally polarized waves do not match.

Examples in which base station antennas are constructed using patch antennas that can be formed more compactly have been proposed in JP-A-H11-510662, JP-A-H11-298225, and JP-A-2003-078339. A patch antenna is both provided with a patch conductor on one surface of a dielectric board and is provided with a ground conductor on the other surface. Such a patch antenna is configured such that a high-frequency signal is supplied to the patch conductor by way of power-supply pins or power-supply lines. This patch antenna is capable of transmitting and receiving linearly polarized waves if the patch conductor, which is a radiation element, is formed in a round or square shape. In addition, the directivity characteristic of the patch antenna is a radiation pattern shape that is forward of the patch conductor.

Further, an antenna for transmitting and receiving linearly polarized waves, which can be transmitted and received by horizontally polarized waves and vertically polarized waves in common on one patch conductor, can be constructed by providing two power-supply circuits that are mounted from mutually orthogonal directions to one patch conductor in a patch antenna (refer to JP-A-2003-078339, JP-A-H07-176942, and JP-A-2002-344238).

### DISCLOSURE OF THE INVENTION

A base-station antenna that uses the patch antenna elements disclosed in JP-A-H11-510662 or JP-A-H11-298225 can realize smaller size or lower cost with comparative ease. However, a base station antenna that uses these antenna elements has a narrower directional beam width than a reflector dipole antenna. A reflector dipole antenna is typically of a configuration in which one direction of a non-directional antenna is cut off by a metallic plate. The directional beam width in the horizontal plane of vertically polarized waves in a reflector dipole antenna of this configuration is 90°, and a reflector dipole antenna is therefore superior because it enables a wider directional beam width in the horizontal plane of vertically polarized waves than a patch antenna.

On the other hand, the directional beam within the horizontal plane of a patch antenna, when there is a limited ground surface in the order of one wavelength, is approximately 70° for vertically polarized waves and 55° for horizontally polarized waves (see FIG. 3). In other words, a patch antenna has a narrower directional beam width than a reflector dipole antenna. In addition, the directional beam width in the horizontal plane of vertically polarized waves and the directional beam width in the horizontal plane of horizontally polarized waves in a patch antenna differ by approximately 15°. As a result, the radiation areas differ when a patch antenna is used as the dual-polarized antenna for both vertically polarized waves and horizontally polarized wave as disclosed in JP-A-2003-078339 and JP-A-H07-176942.

In order to circumvent this problem, antennas that are each separately configured for vertically polarized waves and horizontally polarized waves must be used as disclosed in, for example, JP-A-2002-344238. However, adopting separate antennas for vertically polarized waves and horizontally polarized waves typically necessitates the preparation of two types of antennas, and further results in outer shapes that are different and increased costs.

The above-described JP-A-2003-078339 discloses an antenna device having planar antenna element (patch conductor), dielectric block, passive element, and reflectors. The planar antenna element is formed on one surface of a dielectric substrate and is composed of a metallic plate having a shape that is substantially symmetrical both vertically and horizontally. The dielectric block is a rectangular parallelepiped and is arranged in the radiation plane of the antenna element. The passive element is composed of a metallic plate formed in the vertical direction on the front radiation surface of the dielectric block. The reflectors are each arranged facing a respective radiation direction on the two sides of the dielectric substrate with the planar antenna element in substantially their center position. By adopting the above-described configuration, the above-described antenna device achieves equal directivity in the horizontal plane of both horizontally polarized waves and vertically polarized waves. However, the configuration of this invention, in which a rectangular parallelepiped dielectric block is arranged on the radiation surface of an antenna element and a passive element composed of a metallic plate formed in a vertical direction is provided on the front surface, is comparatively complex.

The invention disclosed in the above-described JP-A-2003-078339 provides a means for equalizing the directivity in the horizontal plane of horizontally polarized waves and vertically polarized waves in a vertical dual-polarization antenna device. However, this invention does not equalize the directivity in a plane that is parallel to the polarization plane of the antenna and the directivity in a plane that is orthogonal to the polarization plane in a single-polarization antenna.

It is an object of the present invention to provide a novel means for enabling a broadening of the directional beam width of a patch antenna by a comparatively simple method.

The patch antenna for linearly polarized waves of the present invention for achieving the above-described object is provided with a patch antenna element that is formed on a dielectric substrate and that is configured to enable the transmission and reception of linearly polarized waves, and metallic walls that are provided at the periphery of the patch antenna element and that tilt inward to reduce the size of the radiation opening of the antenna.

The above-described invention is a device in which the shape of the metallic walls is arranged to, for example, tilt inward to reduce the dimension of the radiation opening of the antenna. In this way, the patch antenna for linearly polarized waves of the present invention enables adjustment of both the directional beam width in a plane that is perpendicular to the polarization plane and the directional beam width in a plane that is horizontal to the polarization plane, i.e., enables a broadening of the directional beam width of the patch antenna.

### BRIEF DESCRIPTION OF THE DRAWINGS

FIG. 1 shows the outer appearance of a reflector dipole antenna that is used as a base station antenna;

FIG. 2 shows the outer appearance of another reflector dipole antenna that is used as a base-station antenna;

FIG. 3 shows the directional beam width in the horizontal plane when related patch antennas are used for vertically polarized waves and horizontally polarized waves;

FIG. 4 is a perspective view of a patch antenna that shows the first embodiment of the present invention;

FIG. 5 is a front elevation of the patch antenna that shows the first embodiment of the present invention;

FIG. 6 is a side view of the patch antenna that shows the first embodiment of the present invention;

FIG. 7 shows the directional beam width in the vertical plane and horizontal plane of the patch antenna in the present embodiment;

FIG. 8 shows the directional beam width in a horizontal plane when the patch antenna of the present embodiment is used for vertically polarized waves and horizontally polarized waves;

FIG. 9 shows a patch antenna that was constructed as a comparative example;

FIG. 10 shows the directional beam width in a horizontal plane when the patch antenna of the comparative example shown in FIG. 9 was used for vertically polarized waves and horizontally polarized waves;

FIG. 11 shows a patch antenna that was constructed as a comparative example;

FIG. 12 shows the directional beam width in a horizontal plane when the patch antenna of the comparative example shown in FIG. 11 was used for vertically polarized waves and horizontally polarized waves;

FIG. 13A is a perspective view of the patch antenna that shows the second embodiment of the present invention;

FIG. 13B is a front elevation of the patch antenna that shows the second embodiment of the present invention;

FIG. 13C is a side view of the patch antenna that shows the second embodiment of the present invention;

FIG. 14A is a perspective view of the patch antenna that shows the third embodiment of the present invention;

FIG. 14B is a front elevation of the patch antenna that shows the third embodiment of the present invention;

FIG. 14C is a side view of the patch antenna that shows the third embodiment of the present invention;

FIG. 15A is a perspective view of the patch antenna that shows the fourth embodiment of the present invention;

FIG. 15B is a front elevation of the patch antenna that shows the fourth embodiment of the present invention;

FIG. 15C is a side view of the patch antenna that shows the fourth embodiment of the present invention;

FIG. 16A is a perspective view of the patch antenna that shows the fifth embodiment of the present invention;

FIG. 16B is a perspective view of the patch antenna that shows the fifth embodiment of the present invention; and

FIG. 16C is a perspective view of the patch antenna that shows the fifth embodiment of the present invention.

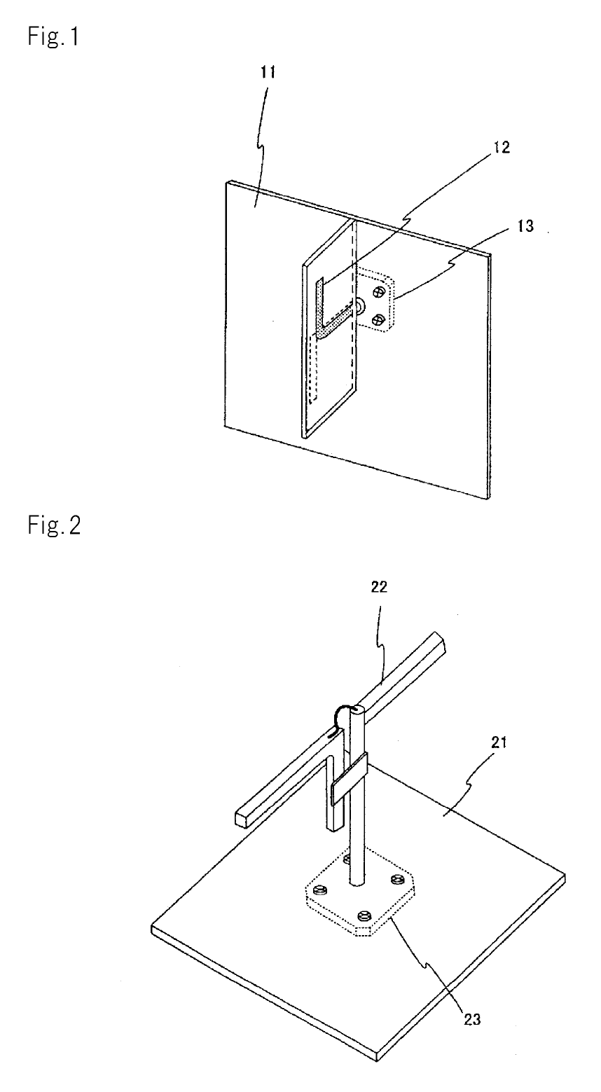

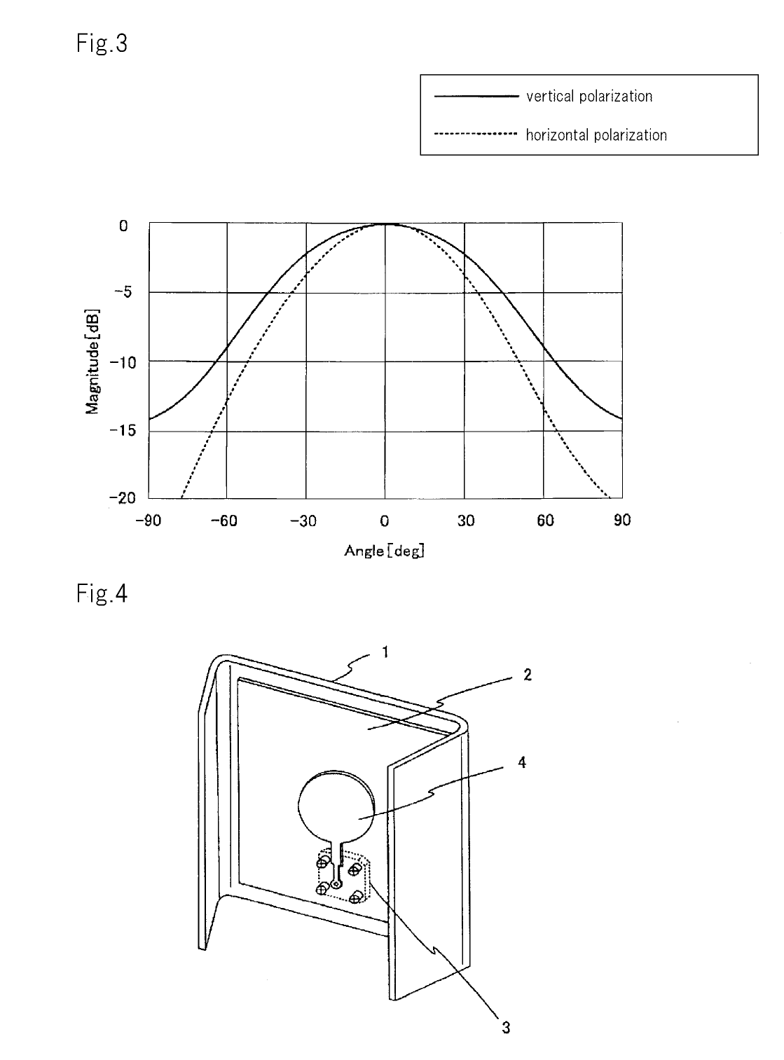

### BEST MODE FOR CARRYING OUT THE INVENTION

The patch antenna for linearly polarized waves of the present invention is provided with: a patch antenna element that is formed on a dielectric substrate and that is configured to allow transmission and reception of linearly polarized waves; and metallic walls that are provided at the periphery of the patch antenna element and that are inclined inward to decrease the size of the radiation opening of the antenna.

The metallic walls of the patch antenna for linearly polarized waves of the present invention can be constituted by a substantially rectangular metallic plate that both supports the entire rear surface of the dielectric substrate and includes bent portions that are bent forward to narrow the spacing between the ends of the metallic walls at the two ends that are parallel to the polarization plane of linearly polarized waves.

A configuration can be adopted in which the bent portions are formed as bent portions that are inclined toward the dielectric substrate. Alternatively, a configuration can be adopted in which the bent portions are bent at substantially a right angle from the periphery of the dielectric substrate and then again bent at a midway point toward the dielectric substrate.

When configured as bent portions that are inclined toward the dielectric substrate, the spacing between the ends of the bent portions may be set to approximately 0.8λ (λ=wavelength) with respect to the wavelength of the patch antenna radiation element, the height of the bent portions may be set to approximately 0.23λ, and the angle of inclination θ of the bent portions that are inclined inwardly may be set to from 65° to 70°. This configuration is even better suited to causing matching of the directional beam widths in the horizontal planes of vertically polarized waves and horizontally polarized waves.

By adopting this type of configuration in the present invention, polarization can be altered without changing the radiation areas of electromagnetic waves, and further, the disadvantages encountered when exchanging antennas can be eliminated.

In addition, the present invention enables the adoption of a configuration in which a passive element is arranged at a prescribed distance in front of the patch antenna element to thus achieve a broader band.

Still further, the patch antenna element can be configured to enable transmission and reception by linearly polarized waves having polarization planes orthogonal to the linearly polarized waves. The metallic walls at this time may be configured such that, regarding each directional beam realized by two linearly polarized waves having polarization planes that are mutually orthogonal, the directional beam width in a plane parallel to the linear polarization plane formed by one linearly polarized wave and the directional beam width in a plane perpendicular to the linear polarization plane formed by the other linearly polarized wave are equal. The patch antenna element is thus capable of causing the radiation areas to match vertically polarized waves and horizontally polarized waves when used as a dual-polarized antenna.

According to the present invention, the directional beam widths of the vertical plane and horizontal plane of a single-polarized antenna can be caused to match.

In addition, according to the present invention, a 90-degree rotation of the single-polarized antenna in which the directional beam widths of the vertical plane and horizontal plane have been matched enables common use as a vertical-polarized antenna and horizontal-polarized antenna.

Still further, according to the present invention, a means can be provided for substantially equalizing the horizontal-plane directional beam widths of vertically polarized waves and horizontally polarized waves in a dual-polarized patch antenna for vertically polarized waves and horizontally polarized waves.

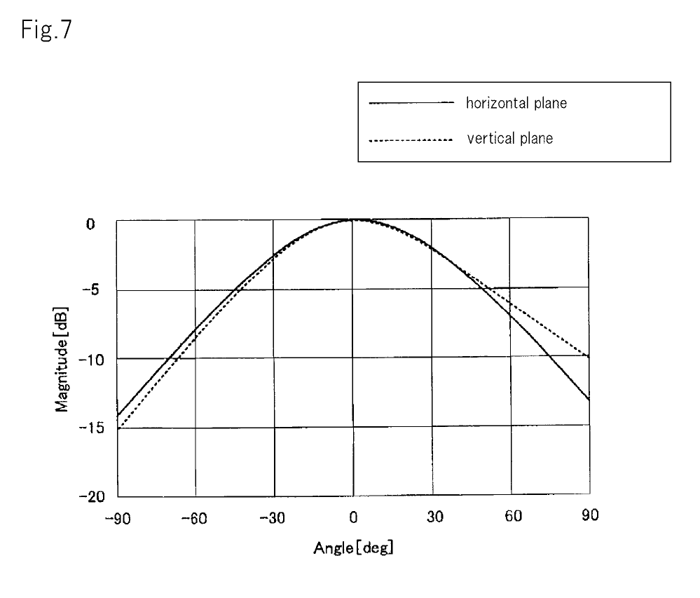

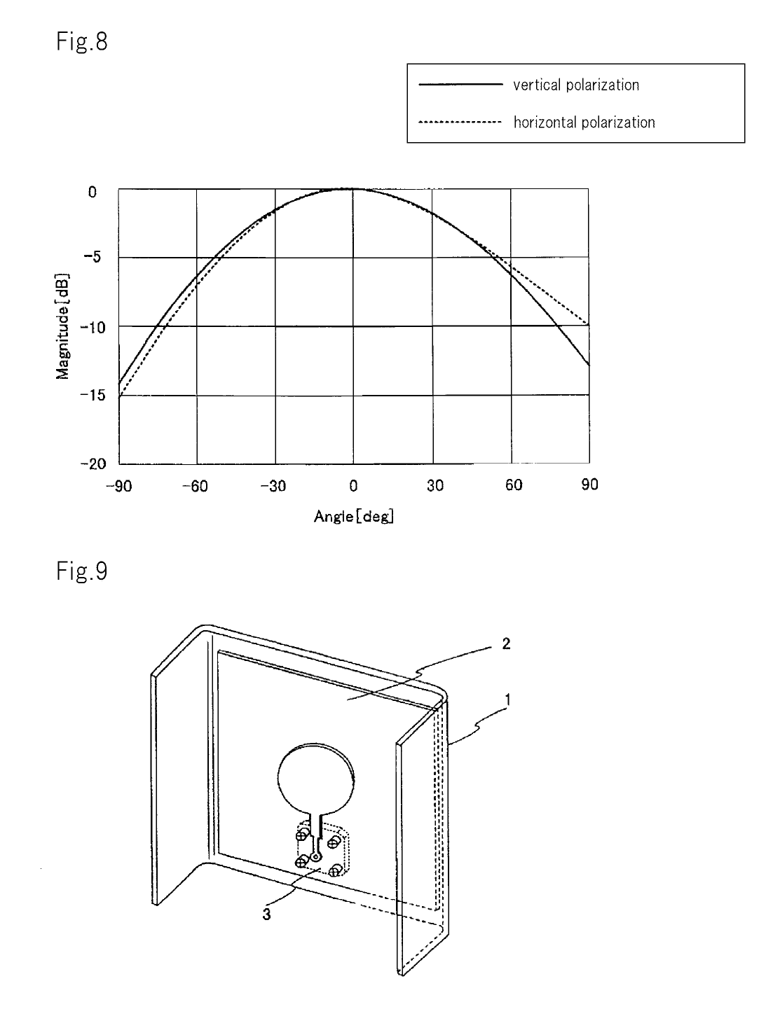

FIGS. 4 to 6 are a perspective view, front elevation, and side view of a patch antenna that shows the first embodiment of the present invention. FIG. 7 shows radiation patterns in the horizontal plane and vertical plane of the patch antenna of the present embodiment. FIG. 8 shows the radiation patterns of the horizontal plane when the patch antenna of the present embodiment is used as a vertical-polarized antenna and when the patch antenna of the present embodiment is used as a horizontal-polarized antenna.

The patch antenna of the present embodiment is made up of metallic walls 1, patch conductor 4, and coaxial connector 3. Patch conductor 4 is formed in a round shape by, for example, etching on printed board 2, which is a dielectric substrate. This patch conductor 4 is supplied with power by way of coaxial connector 3 from the rear surface of metallic walls 1.

Metallic walls 1 can be constructed from one substantially rectangular metal plate with the rear surface of printed board 2 adhered to its center. Metallic walls 1 are further bent toward the front from the side surfaces of printed board 2 and along the side surfaces of the printed board. The bent portions of metallic walls 1 are inclined inward. In addition, the spacing between the ends of the two bent portions of metallic walls 1 is smaller than the dimension of the radiation opening of the patch antenna as seen from the direction of radiation of the antenna. In other words, the radiation opening of the patch antenna is narrowed by the inward inclination of metallic walls 1 of the two ends of printed board 2.

The operation of the patch antenna of the present embodiment is next explained according to the flow of a microwave signal during transmission. In the case of reception, the direction of flow of the microwave signal is simply the reverse because reversibility is realized and the characteristics are identical.

The microwave signal transmitted from the transmitter is supplied to patch conductor 4 from coaxial connector 3 by way of a coaxial cable. The above-described microwave signal is radiated from this patch antenna by linearly polarized waves that have a polarization plane parallel to the vertical direction of FIG. 4. The transmitter and coaxial cable are not directly relevant to the present invention and detailed description of these components is therefore here omitted.

Typically, the directional beam width of the horizontal plane of a patch antenna is wider than the directional beam width of the vertical plane in the case of vertically polarized waves, but is narrower than the directional beam width of the horizontal plane realized by a dipole antenna. However, when a configuration is adopted in which the two ends of metallic walls 1 are bent along the two ends of printed board 2 and are inwardly inclined, as in the present embodiment, the dimensions of the radiation opening in the horizontal plane are reduced and the directional beam width of the horizontal plane is therefore wider.

Regarding the vertical plane, magnetic current flows on the inner surfaces of metallic walls 1 that are inwardly inclined, and the magnetic current at the bases of inwardly inclined metallic walls 1 and at the radiation opening offset each other, and the directional beam width of the vertical plane is therefore broader. Due to the two effects described above, the patch antenna of the present embodiment can both broaden the directional beam widths of the vertical plane and horizontal plane, and further, cause the two directional beam widths to match.

FIG. 7 shows the radiation pattern characteristic in the vertical plane and horizontal plane of the patch antenna shown in FIGS. 4 to 6 in the following settings. Specifically, the spacing between the ends of the bent portions of metallic walls 1 is set to approximately 0.8λ (where λ is the wavelength) with respect to the wavelength of the patch antenna radiation element. The dimension of approximately 0.8λ is within the range of from 0.79λ to 0.81λ. The height of the bent portions is set to approximately 0.23λ. The dimension of approximately 0.23λ is within the range of from 0.22λ to 0.24λ. The angle of inclination θ of the inwardly inclined bent portions is set to from 65° to 70°. As shown in FIG. 7, the patch antenna of the present embodiment with the above-described settings obtains a radiation pattern characteristic in which the directional beam width is approximately 85° in either the vertical plane or horizontal plane.

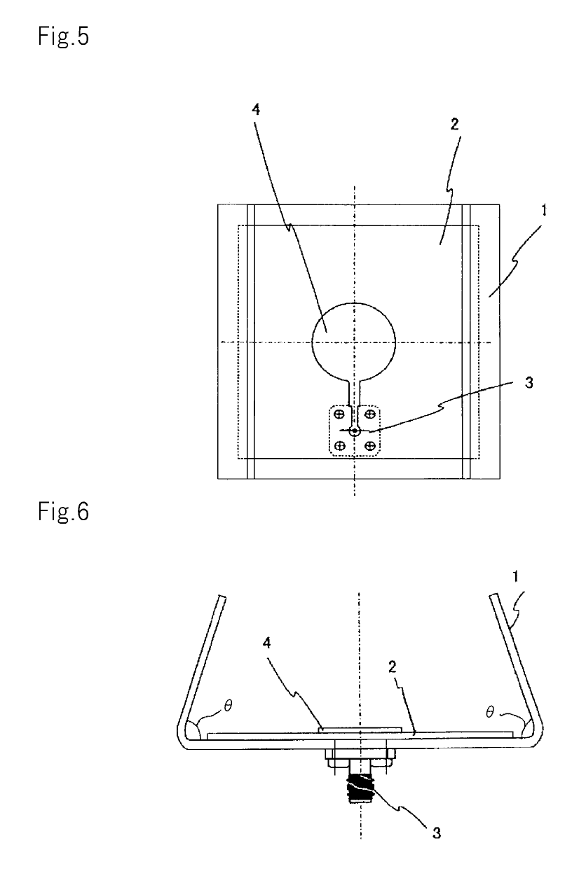

Accordingly, the single-polarized patch antenna of the present embodiment can equalize the directional beam widths of the horizontal plane as shown in FIG. 8 when used for either type of an antenna for vertical-polarized transmission/reception or an antenna for horizontal-polarized transmission/reception. In other words, when the patch antenna of the present embodiment is used as an antenna for vertical-polarized transmission/reception, the polarization plane should be arranged to match the vertical direction as shown in FIGS. 4 and 5. On the other hand, when the patch antenna of the present embodiment is used as an antenna for horizontal-polarized transmission/reception, {the patch antenna} should be rotated 90° from the state shown in FIGS. 4 and 5 such that the polarization plane is set to match the horizontal direction.

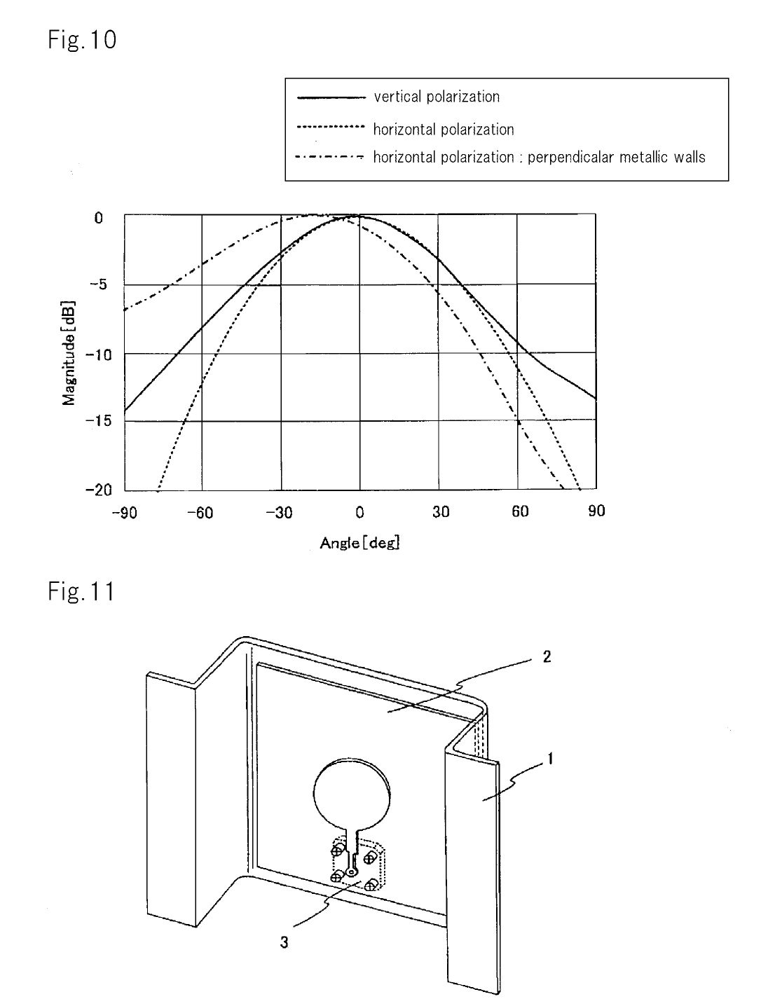

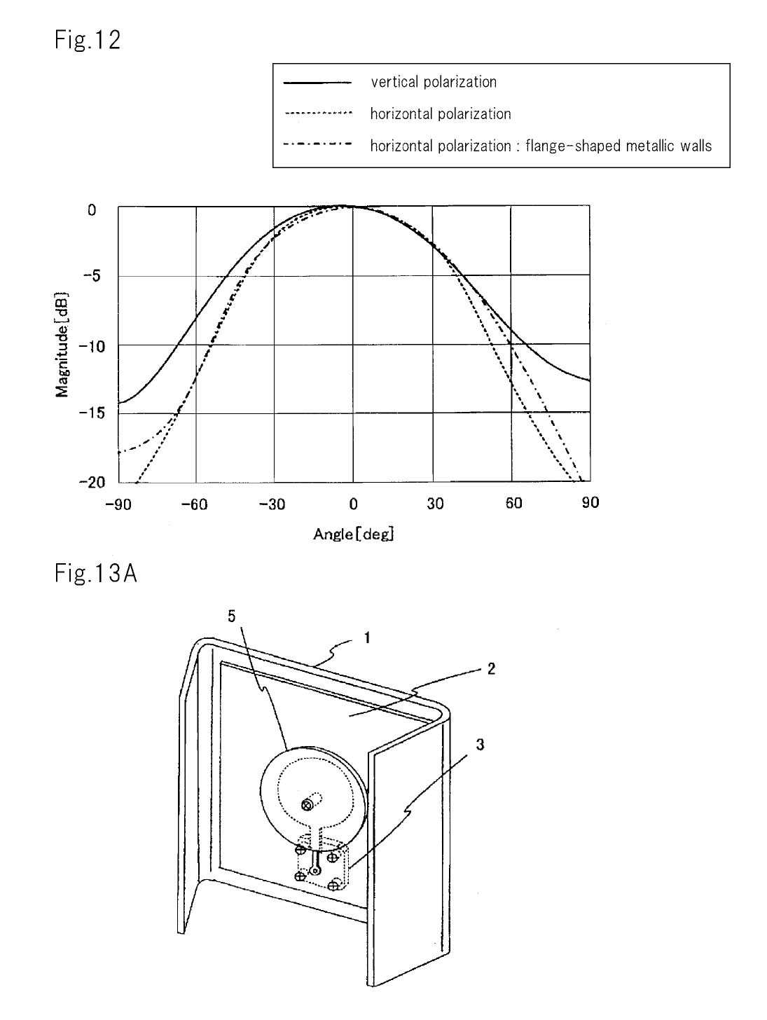

FIGS. 9 and 11 show patch antennas that were constructed as comparative examples, and FIGS. 10 and 12 show the radiation patterns in these comparative examples.

In the example shown in FIG. 9, metallic walls 1 at the two ends of printed board 2 are perpendicular to printed board 2. In this case, the directional beam width of horizontally polarized waves is in the order of 20° wider than the patch antenna of the art that is related to the present invention, as shown in FIG. 10. However, the radiation direction having the maximum gain of the antenna differs from the mechanical front direction of the antenna.

In the example shown in FIG. 11, metallic walls 1 are perpendicular to printed board 2, and in addition, have a flange shape in which the ends are made parallel to printed board 2. In this case, the directional beam width of the horizontal plane is not broadened as shown in FIG. 12.

Thus, according to the patch antenna of the present embodiment, an antenna for vertically polarized waves and an antenna for horizontally polarized waves for which the directional beam widths in the horizontal plane are equal can be provided by one type of patch antenna having a comparatively simple construction, whereby the installation costs of a base station antenna can be reduced.

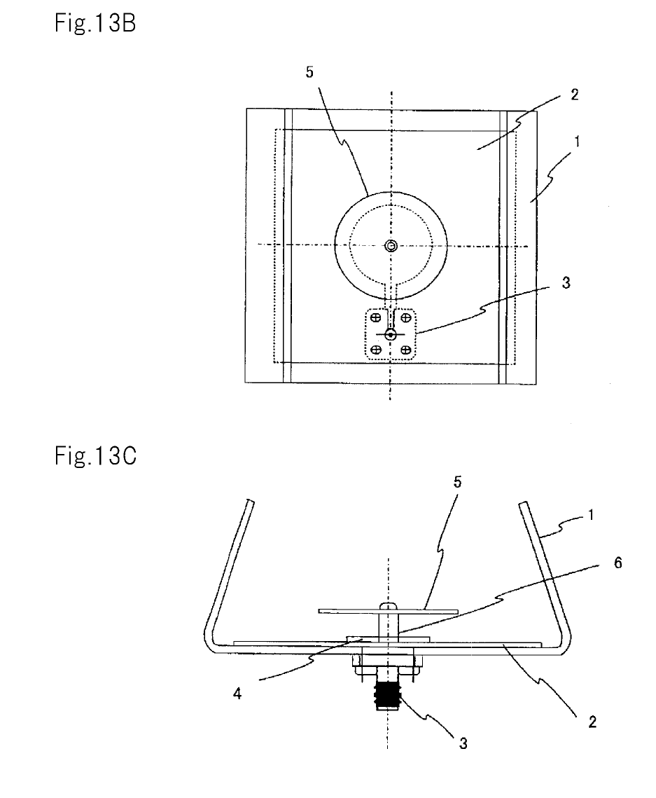

FIGS. 13A-13C are a perspective view, a front elevation, and a side view, respectively, of a patch antenna that represents the second embodiment of the present invention.

In the present embodiment, passive element 5 for broadening the band is mounted by way of spacer 6 on the radiation surface of a patch antenna that is formed on printed board 2. The radiation pattern and other effects of the antenna are similar to the first embodiment.

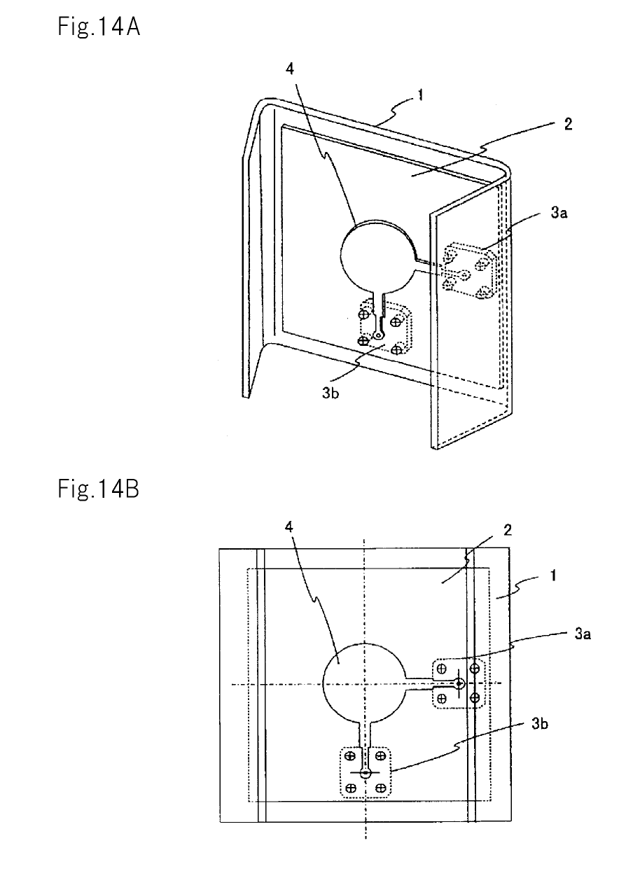

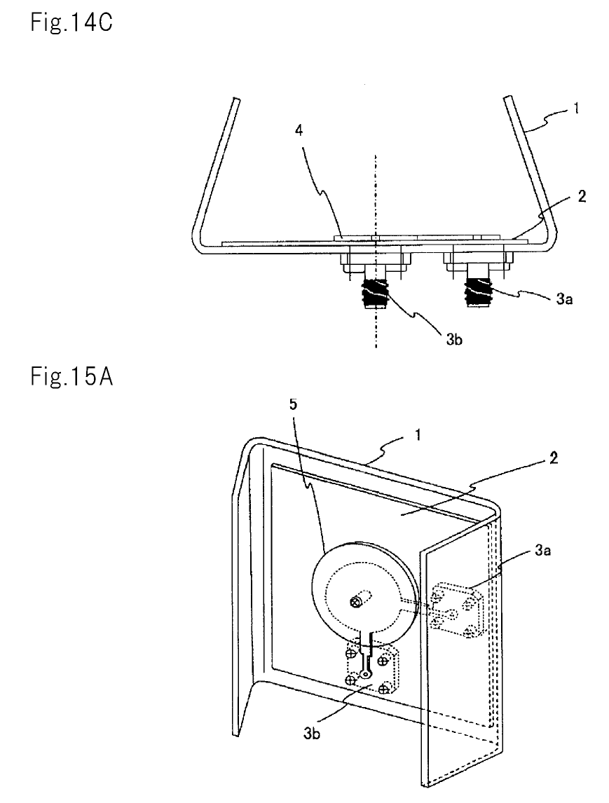

FIGS. 14A-14C are a perspective view, a front elevation, and a side view, respectively, of a patch antenna that represents the third embodiment of the present invention.

The present embodiment is made up from metallic walls 1, a patch antenna element arranged by, for example, etching on printed board 2, and coaxial connectors 3a and 3b. The patch antenna has a round or square shape formed by the printed board and is supplied from coaxial connectors 3a and 3b by way of the rear surface of metallic walls 1.

In the present embodiment, connector terminals for vertically polarized waves and horizontally polarized waves are provided to make the patch antenna a dual-polarized antenna. Metallic walls 1 are arranged with an inward inclination such that metallic walls 1 are smaller than the dimension of the radiation opening of the patch antenna as seen from the direction of antenna radiation.

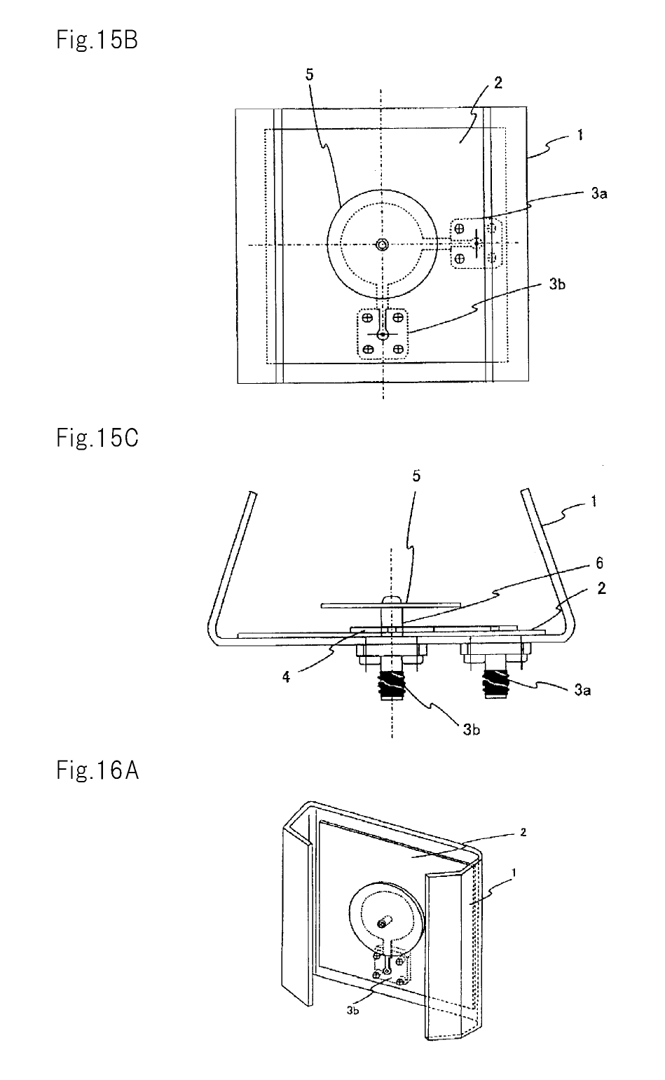

FIGS. 15A-15C are a perspective view, a front elevation, and a side view, respectively, of the patch antenna that represents the fourth embodiment of the present invention.

The present embodiment is made up of metallic walls 1, a patch antenna element arranged by, for example, etching on printed board 2, coaxial connectors 3a and 3b, passive element 5, and spacer 6. The patch antenna is formed by the printed board, has a round or square shape, and is supplied from coaxial connectors 3a and 3b by way of the rear surface of metallic walls 1. Passive element 5 for broadening the band is mounted on the radiation surface of the patch antenna with spacer 6 interposed.

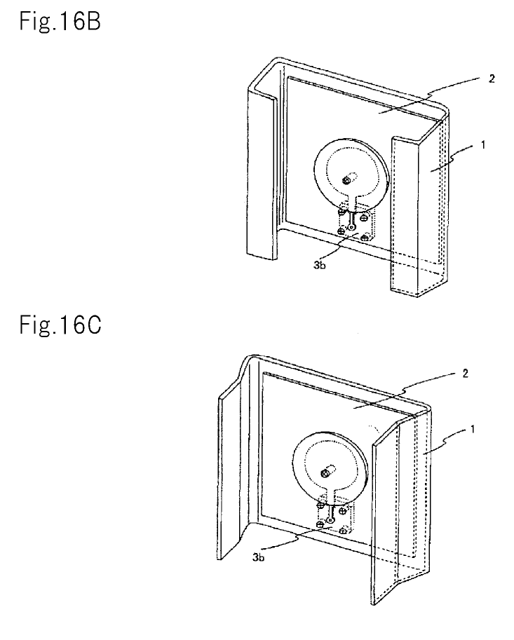

FIGS. 16A-16C are perspective views of the patch antenna that represents the fifth embodiment of the present invention.

In each of the embodiments described hereinabove, configurations were used in which the shapes of metallic walls 1 were bent portions that were each a single plane inclined toward the printed board. In contrast, the present embodiment adopts a shape in which the each bent portion is again bent midway to narrow the antenna opening plane. The configuration is otherwise identical to the above-described embodiments, and further, the radiation pattern and other effects are also identical to those of the above-described embodiments. These metallic walls can be constructed by subjecting one substantially rectangular metallic plate to a bending process, whereby lower cost can be realized.

Although the invention of the present application was described with reference to embodiments, the invention of the present application is not limited to the above-described embodiments. The construction and details of the present invention may use appropriate combinations of the above-described embodiments, and further, may be modified as appropriate within the scope of the claims of the present invention.

This application claims the benefits of the priority based on of JP-A-2007-118946 for which application was submitted on Apr. 27, 2007 and incorporates all disclosures of that application by citation.

1-9. (canceled)

10. A patch antenna for linearly polarized waves comprising:
a patch antenna element that is formed on a dielectric substrate and that is configured to enable transmission and reception of linearly polarized waves; and metallic walls that are provided at the periphery of the patch antenna element and that tilt inward to reduce the size of the radiation opening of the antenna.

11. The patch antenna for linearly polarized waves according to claim 10, wherein said metallic walls are constructed of a substantially rectangular metallic plate that both supports the entire rear surface of said dielectric substrate and includes bent portions that are bent forward to narrow the spacing between the ends of said metallic walls that are parallel to the polarization plane of said linearly polarized waves.

12. The patch antenna for linearly polarized waves according to claim 11, wherein said bent portions are constructed as bent portions that tilt toward said dielectric substrate.

13. The patch antenna for linearly polarized waves according to claim 12, wherein the spacing between the ends of said bent portions is set to approximately 0.8 with respect to wavelength of the patch antenna radiation element, the height of said bent portions is set to approximately 0.23, and the angle of inclination of said bent portions that are inclined inward is set to from 65° to 70°.

14. The patch antenna for linearly polarized waves according to claim 11, wherein said bent portions are bent at approximately a right angle from the periphery of said dielectric substrate, and are again bent from a mid-point toward said dielectric substrate.

15. The patch antenna for linearly polarized waves according to claim 10, wherein said metallic walls are constructed such that the directional beam width in a plane that is parallel to the polarization plane of said linearly polarized waves matches the directional beam width in a plane that is orthogonal to the polarization plane of said linearly polarized waves.

16. The patch antenna for linearly polarized waves according to claim 10, wherein a passive element is arranged separated by a predetermined distance in front of said patch antenna element.

17. The patch antenna for linearly polarized waves according to claim 10, wherein said patch antenna element is constructed to allow transmission and reception by linearly polarized waves having a polarization plane that is orthogonal to said linearly polarized waves.

18. The patch antenna for linearly polarized waves according to claim 17, wherein said metallic walls are constructed such that, regarding directional beams realized by said two linearly polarized waves having polarization planes that are mutually orthogonal, the directional beam width in a plane parallel to the linear polarization plane formed by one linearly polarized wave is equal to the directional beam width in a plane perpendicular to the linear polarization plane formed by the other linearly polarized wave.

19. The patch antenna for linearly polarized waves according to claim 11, wherein said metallic walls are constructed such that the directional beam width in a plane that is parallel to the polarization plane of said linearly polarized waves matches the directional beam width in a plane that is orthogonal to the polarization plane of said linearly polarized waves.

20. The patch antenna for linearly polarized waves according to claim 12, wherein said metallic walls are constructed such that the directional beam width in a plane that is parallel to the polarization plane of said linearly polarized waves matches the directional beam width in a plane that is orthogonal to the polarization plane of said linearly polarized waves.

21. The patch antenna for linearly polarized waves according to claim 13, wherein said metallic walls are constructed such that the directional beam width in a plane that is parallel to the polarization plane of said linearly polarized waves matches the directional beam width in a plane that is orthogonal to the polarization plane of said linearly polarized waves.

22. The patch antenna for linearly polarized waves according to claim 14, wherein said metallic walls are constructed such that the directional beam width in a plane that is parallel to the polarization plane of said linearly polarized waves matches the directional beam width in a plane that is orthogonal to the polarization plane of said linearly polarized waves.

23. The patch antenna for linearly polarized waves according to claim 11, wherein a passive element is arranged separated by a predetermined distance in front of said patch antenna element.

24. The patch antenna for linearly polarized waves according to claim 12, wherein a passive element is arranged separated by a predetermined distance in front of said patch antenna element.

25. The patch antenna for linearly polarized waves according to claim 13, wherein a passive element is arranged separated by a predetermined distance in front of said patch antenna element.

26. The patch antenna for linearly polarized waves according to claim 14, wherein a passive element is arranged separated by a predetermined distance in front of said patch antenna element.

27. The patch antenna for linearly polarized waves according to claim 15, wherein a passive element is arranged separated by a predetermined distance in front of said patch antenna element.

28. The patch antenna for linearly polarized waves according to claim 11, wherein said patch antenna element is constructed to allow transmission and reception by linearly polarized waves having a polarization plane that is orthogonal to said linearly polarized waves.

29. The patch antenna for linearly polarized waves according to claim 12, wherein said patch antenna element is constructed to allow transmission and reception by linearly polarized waves having a polarization plane that is orthogonal to said linearly polarized waves.
